(19) United States
(12) Patent Application Publication
(10) Pub. No.: US 2016/0050882 A1
(43) Pub. Date: Feb. 25, 2016

(54) Pet Portable Articulated Walkway (PetPAW)

(71) Applicant: Gina Michelle Longo, Durham, NC (US)

(72) Inventor: Gina Michelle Longo, Durham, NC (US)

(21) Appl. No.: 14/831,868

(22) Filed: Aug. 20, 2015

Related U.S. Application Data
(63) Continuation of application No. 62/039,854, filed on Aug. 20, 2014.

(51) Int. Cl. A01K 3/00; A01K 29/00; A01K 1/00

(52) U.S. Cl. CPC A01K 3/00; A01K 1/0035; A01K 29/00

(57) ABSTRACT

The Pet Portable Articulated Walkway (PetPAW) is a portable pet ramp with integral protective folding sides and locking handles. The PetPAW is designed to allow owners of large and/or infirm pets to assist their pets in moving between heights (as from the ground to a car or other such distance) safely. The PetPAW s integral sides provide visual and physical protection from falls or missteps by the animals, and improved handle locking and securing features provide increased user protection against injury to hands and fingers during use.

### CROSS-REFERENCE TO RELATED APPLICATIONS

Provisional Patent Application Number: 62039854
Date of Submission: 20 Aug. 2014
EFS ID: 19921508

### STATEMENT REGARDING FEDERALLY-SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field Of Endeavor

This invention relates generally to the handling of animals and to accessories used to facilitate the movement of said animals, particularly large companion animals, into and out of vehicles or other locations which the animal's age, size, weight, and/or infirmity, and/or the height of the destination make it difficult or impossible for the animal to achieve either on its own or with human assistance.

Specifically, the present invention relates to a portable articulated walkway with integral folding protective side panels which are designed to provide the animal with both physical protection from potential falls from height when traversing the walkway into or out of the vehicle or other location, and visual cues to ensure that the animal is able to enter and exit the walkway surface only straight on from either end, thereby preventing the animal from either stepping off of the side of the walkway or jumping or falling while traversing the walkway surface.

2. Background

As companion animals, or pets, have become more and more part of our everyday lives, it is becoming commonplace for them to be included in our daily plans. In addition to cars, trucks, and sport utility vehicles, along with other forms of transport, companion animals are sometimes required to enter or exit other locations (such as a raised examination table, crate, or kennel) to which they may be unable to gain access without assistance. Many companion animals are too large or too heavy to be lifted with ease and without danger of injury either to the companion animal or to the person attempting to lift the animal, and other pets are simply too aged and/or too infirm to enter or exit the desired location without some form of assistance.

Because of these situations, a small number of pet ramps or other similar devices have been previously created to solve the problem of assisting large, aged, or injured pets into and out of either a vehicle or other location. However, all of the current devices are simply flat platforms, usually but not always portable, and none offer any form of protection from falls or missteps by the animals.

There is therefore a need for an advanced apparatus, which in addition to providing a means for the animal to gain access to locations at differing heights, also provides adequate protection, both physical and visual, from jumps, falls, and missteps while traversing the apparatus' surface. To fulfill this need, a portable articulated walkway with integral folding protective side panels is hereby proposed.

Furthermore, due to the inadequate securing mechanisms present on current incarnations of available pet ramps, there is also a need for an increased securing capability of the apparatus in its folded and closed position to prevent injuries to the user. Securing features on current devices do not prevent the devices from partially unfolding while being carried or moved, and this lack of proper securing mechanisms when the devices are folded exposes the user to possible injury. Fingers, hands, or other body parts may come in contact with the edges of the device and may become caught or trapped in the gap created between the two halves of the walkway that can appear when the apparatus partially unfolds due to its inadequate securing mechanisms. When the loosely-secured apparatus returns unexpectedly to its fully-folded position, injuries may result.

### SPECIFIC DOCUMENTS RELATED TO THIS INVENTION

U.S. Pat. No. 6,119,634
U.S. Pat. No. 6,691,645
U.S. Pat. No. D599,062
U.S. Pat. No. 1,639,879
U.S. Pat. No. 5,870,788
U.S. Pat. No. 5,671,496

### BRIEF SUMMARY OF THE INVENTION

It is therefore a principal objective of the present invention to present a portable articulated walkway with integral folding protective side panels, light enough for easy transport but strong enough to support large companion animals. This walkway will provide both physical protection and visual cues to the companion animal to aid in preventing falls and/or missteps while traversing the walkway, which will therefore also help to prevent potential injuries to the pet.

In brief, the portable articulated walkway with integral folding protective side panels in its currently proposed configuration will consist of either a strong molded plastic for the two walkway segments (upper and lower) or of lightweight aluminum also of sufficient strength to support large pets. Such lightweight aluminum can be seen in use in ramps for wheelchair users.

The upper surface of the walkway as proposed will have a non-slip physical design (i.e., be molded or configured so as not to be completely smooth), and will in addition be covered with a non-slip/non-skid material, such as indoor/outdoor carpeting or the like. This addition of a non-slip/non-skid covering will help to prevent the companion animal from slipping and possibly being injured while using the walkway. Most current incarnations of pet ramps do not incorporate this additional covering, and therefore they are prone to becoming very slippery and dangerous, particularly if either the ramp or the pet's feet are wet.

The four integral folding protective side panels, as proposed, will also be formed of either molded plastic or of lightweight aluminum. Constructing the folding protective side panels of a lightweight aluminum may allow for later extension capability of the panels if an extender mechanism is included. This so-called extender capability, if incorporated, will allow for additional protection of taller animals while still providing for the ability of the folding protective side panels to be completely contained within the width of the walkway when the panels are folded when the walkway is not in use.

While nothing in this description precludes this invention from being constructed out of lightweight aluminum as described above, the invention in its current proposed form is assumed to be constructed out of molded plastic with steel used for the center hinge joint, hinges, and locking pins.

Another principal objective of the present invention is to incorporate various handles and locking mechanisms as well as a centrally-located hinged locking pin. The handles and their corresponding molded plastic or aluminum locking and securing mechanisms will serve a dual purpose: one, to lock the walkway into a tightly-folded position when not in use, thus preventing or minimizing potential injuries to users, and two, for carrying the portable walkway from one location to another. The hinged locking pin will ensure that the walkway remains in a securely-locked and safe position when unfolded and extended for use, thus preventing the walkway from inadvertently moving into a partially-folded position which is unsuitable for use by the companion animal.

This proposed portable articulated walkway with integrated folding protective side panels will help to prevent companion animals from falling, and thereby possibly injuring themselves, while using the walkway, and it will also help pet owners to transport their pets without danger of injury to themselves.

### BRIEF DESCRIPTION OF THE SEVERAL VIEWS OF THE DRAWING

FIG. 1 is an illustration of an overhead view of the entire portable articulated walkway in a fully-extended and locked position.

FIG. 2 is an illustration of the upper section of the walkway with a folding protective side panel in its extended and upright position, showing the locations of the various features of the upper section of the walkway.

FIG. 3 is an illustration of the lower section of the walkway with a folding protective side panel in its extended and upright position, showing the locations of the various features of the lower section of the walkway.

FIG. 4 is an illustration of the underside view of the upper section of the walkway.

FIG. 5 is an illustration of the underside view of the lower section of the walkway.

FIG. 6 is an illustration of a magnified view of the inside of the walkway base lateral end panels, showing the raised-edge guide channels and raised-edge guide channel notches which accommodate the hinges and hinge pins for the folding protective side panels. Each inside walkway base lateral end panel of both the upper and lower walkway ends will contain these channels and notches, comprising a total of four walkway base lateral end panels.

FIG. 7 is an illustration of a magnified longitudinal end view of the folding protective side panel, hinge, hinge pin, and upright locking mechanism (right panel).

FIG. 8 is an illustration of a magnified longitudinal end view of the folding protective side panel, hinge, hinge pin, and upright locking mechanism (left panel).

FIG. 9 is an illustration of the side view of the folding protective side panel showing the hinge and hinge pin, and the locations of the center fasteners and upright locking mechanism.

FIG. 10 is an illustration of a magnified longitudinal end view of the folding protective panel (right side), showing the raised center fastener studs.

FIG. 11 is an illustration of a magnified longitudinal end view of the folding protective side panel (left side), showing the circular center fastener holes.

FIG. 12 is an illustration of the side view of the folded walkway, with the handles and hinged locking pin secured in an unlocked position. The left and right sides of the walkway are identical.

FIG. 13 is an illustration of the side view of the folded walkway, with the handles in their locked positions and the hinged locking pin secured in its unlocked position. The left and right sides of the walkway are identical.

FIG. 14 is an illustration of a magnified side view of the extended walkway in a locked position.

### DETAILED DESCRIPTION OF THE INVENTION

As pets have become more and more part of our everyday lives, it is becoming commonplace for them to be included in our daily plans, and sometimes they need assistance when preparing to travel with us. The PetPAW is a portable articulated walkway with integral folding protective side panels, light enough for easy transport but strong enough to support large pets. This walkway will provide both physical protection and visual cues to the pet to aid in preventing falls, jumps, and/or missteps while traversing the walkway, which will therefore also help to prevent potential injuries to the pet.

The walkway with its integral folding protective side panels will consist of a strong molded plastic for the two walkway segments (upper and lower). The four integral folding protective side panels will also be formed of molded plastic. Steel is used for the center hinge joint, hinges, and locking pins.

The upper surface of the walkway will have a non-slip physical design and will in addition be covered with a non-slip/non-skid material, such as indoor/outdoor carpeting or the like. This addition of a non-slip/non-skid covering will help to prevent the pet from slipping and possibly being injured while using the walkway. Most current incarnations of pet ramps do not incorporate this additional covering, and therefore they are prone to becoming very slippery and dangerous, particularly if either the ramp or the pet's feet are wet.

Additionally, securing features on current devices do not prevent the devices from partially unfolding while being carried or moved, and this lack of proper securing mechanisms when the devices are folded exposes the user to possible injury. Fingers, hands, or other body parts may come in contact with the edges of the device and may become caught or trapped in the gap created between the two halves of the walkway that can appear when the apparatus partially unfolds due to its inadequate securing mechanisms. When the loosely-secured apparatus returns unexpectedly to its fully-folded position, injuries may result.

To solve this problem, the PetPAW also incorporates various handles and locking mechanisms as well as a centrally-located hinged locking pin. The handles and their corresponding locking and securing mechanisms will serve a dual purpose: one, to lock the walkway into a tightly-folded position when not in use, thus preventing or minimizing potential injuries to users, and two, for carrying the portable walkway from one location to another. The hinged locking pin will ensure that the walkway remains in a securely-locked and safe position when unfolded and extended for use, thus preventing the walkway from inadvertently moving into a partially-folded position which is unsuitable for use by the pet.

The PetPAW with its integral folding protective side panels will help to prevent pets from falling and thereby possibly injuring themselves while using the walkway, and it will also help pet owners to transport their pets without danger of injury to themselves.

The PetPAW incorporates folding protective side panels to the walkway, thereby providing both physical and visual protections against falls, jumping, or missteps by pets as they traverse the walkway.

The PetPAW also incorporates locking handles which ensure that the walkway remains securely folded when not in use, thereby helping to prevent injuries to the pet owner as the walkway is transported or carried.

The PetPAW solves two problems inherent in current pet ramps:

1) With its protective side panels, it helps to prevent falls, jumping, or missteps by the pet as the walkway is traversed. The panels, when raised upright, provide visual cues to the pet as to the location of the walkway edges and also help to provide physical protection from injuries resulting from falls.

2) With its locking handles, it helps to prevent injuries to the user (such as crushing or pinching of the hands) by ensuring that the walkway remains securely locked in its fully-closed position when not in use.

Existing pet ramps do not incorporate features which help to prevent falls, missteps, or jumps, nor do existing pet ramps appear to incorporate any features that ensure the ramp remains completely closed when not in use so as to prevent injuries to the user.

The competitive advantage of the PetPAW is its focus on both pet and owner safety with the addition of folding protective side panels and locking handles, while it simultaneously retains the portability and strength features which can be found in current pet ramps.

### Drawings

### Detailed Description of the Drawings

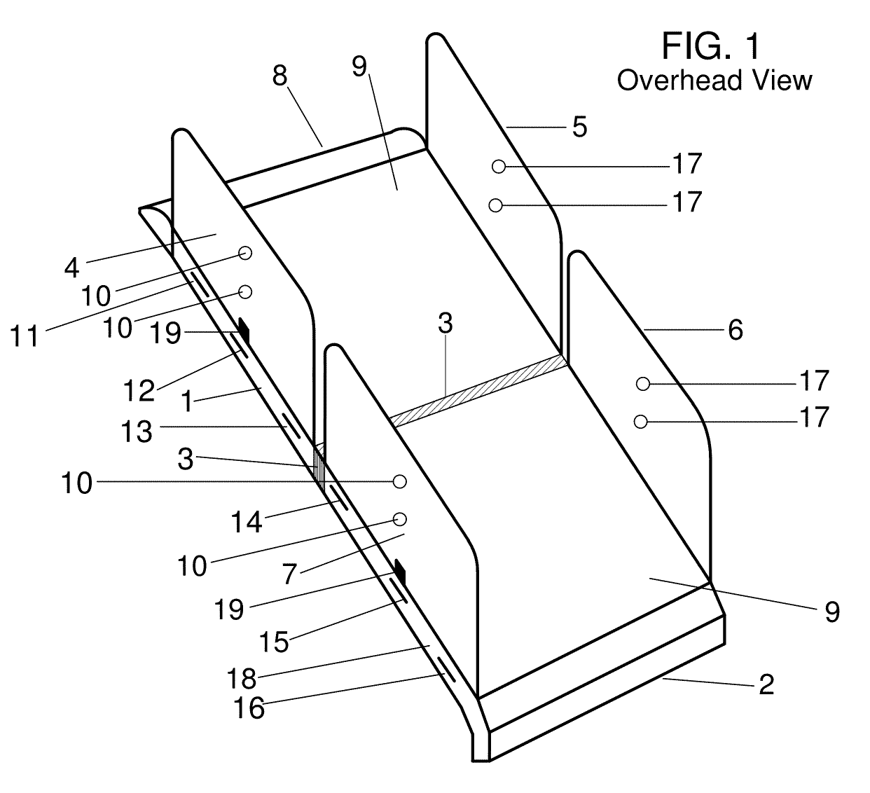

Referring to FIG. 1 of the drawings, the entire walkway in its proposed embodiment is shown in a fully-extended and locked position, ready for use by the pet. The non-skid top end of the walkway 8 is assumed to be supported by a vehicle or other raised surface (not shown), while the non-skid bottom end of the walkway 2 is placed on the ground, floor, or other flat surface.

The apparatus includes the upper section of the walkway base 1 and the lower section of the walkway base 18. The upper and lower walkway sections are connected by a sturdy walkway center hinge joint 3. The walkway center hinge joint 3 is shown in FIG. 1 to demonstrate its location within the apparatus, but when the walkway is fully extended and locked, this walkway center hinge will be concealed, as the two walkway sections will be flush with each other. The walkway center hinge joint 3 allows the walkway sections to be folded and closed or unfolded and extended as necessary.

The walkway incorporates four folding protective side panels 4, 5, 6, and 7, which can be folded into their closed position or opened into their upright position by means of a hinge (not shown) located beneath the walkway floor 9, as the folding protective side panels extend upward through the walkway floor 9. When folded onto the walkway base into a locked position when the walkway is not in use, the folding protective side panels 4, 5, 6, and 7 are secured in place by circular center fastener holes 10, whose locations are shown on the left upper and lower side panels, which are secured onto the raised center fastener studs 17 on the right upper and lower side panels.

The forward handle location 11 is shown along with the corresponding locking mechanism location 16. The center handle location 12 is shown along with the corresponding locking mechanism location 15. The hinged locking pin location 13 and the corresponding locking mechanism location 14 are shown. Finally, the folding protective side panels' upright locking mechanisms locations 19, which serve to hold the panels in an extended and upright position when the walkway is in use, are shown on the two left-side panels. Identical upright locking mechanisms are located in corresponding positions on the two right-side panels.

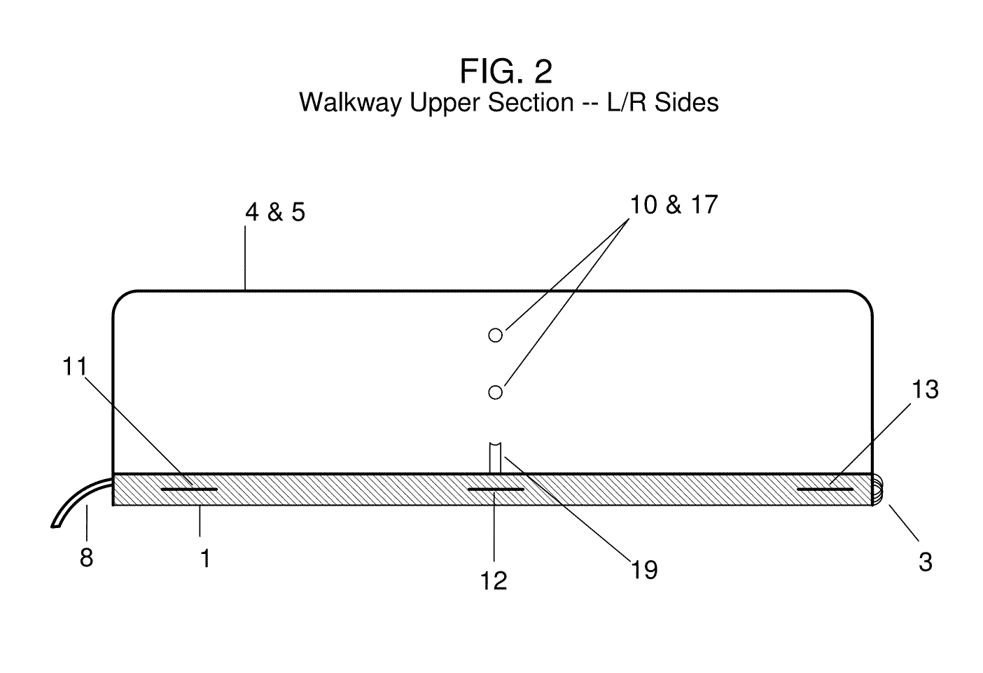

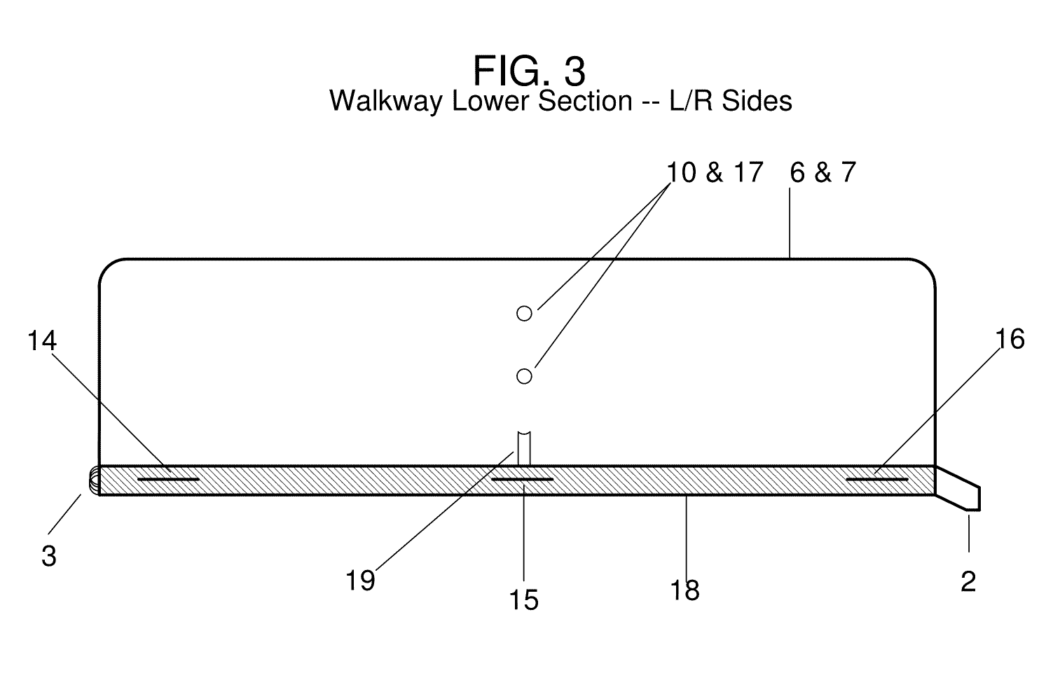

Referring to FIG. 2 of the drawings, the upper section of the walkway is depicted in order to demonstrate the locations of the walkway's various features. The non-skid top end of the walkway 8 is attached to or molded as part of the upper end of walkway base 1. Walkway center hinge joint 3 is connected both to the upper section of walkway base 1 and to the lower section of the walkway base (shown in FIG. 3). The folding protective side panels 4 and 5 are connected to the walkway base by means of hinges (not shown) located beneath the walkway floor. The drawing shows the locations of the center fasteners 10 and 17 which secure the left and right folding protective side panels together when the walkway is not in use. The center handle location 12, forward handle location 11, and hinged locking pin location 13 are shown. Finally, the folding protective side panel upright locking mechanism location 19 is shown.

Referring to FIG. 3 of the drawings, the lower section of the walkway is depicted in order to demonstrate the locations of the walkway's various features. The non-skid bottom end of the walkway 2 is attached to or molded as part of the lower end of walkway base 18. Walkway center hinge joint 3 is connected both to the lower section of walkway base 18 and to the upper section of the walkway base (shown in FIG. 2). The folding protective side panels 6 and 7 are connected to the walkway base by means of hinges (not shown) located beneath the walkway floor. The drawing shows the locations of the center fasteners 10 and 17 which secure the left and right folding protective side panels together when the walkway is not in use. The center handle locking mechanism location 15, forward handle locking mechanism location 16, and hinged locking pin locking mechanism location 14 are shown. Finally, the folding protective side panel upright locking mechanism location 19 is shown.

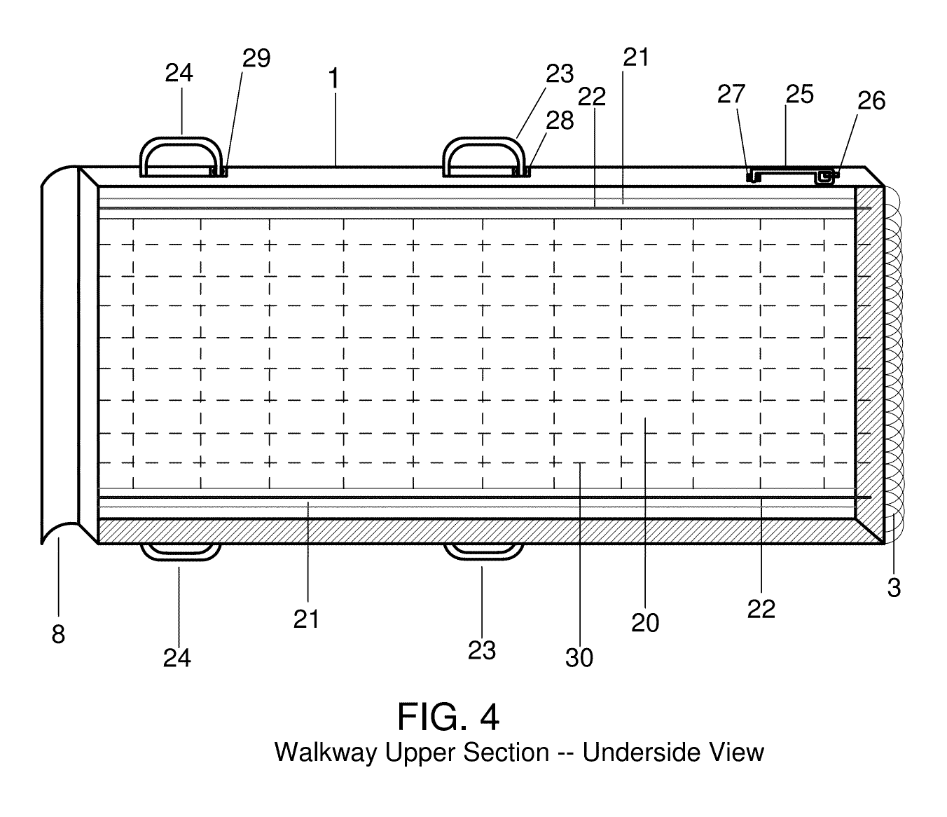

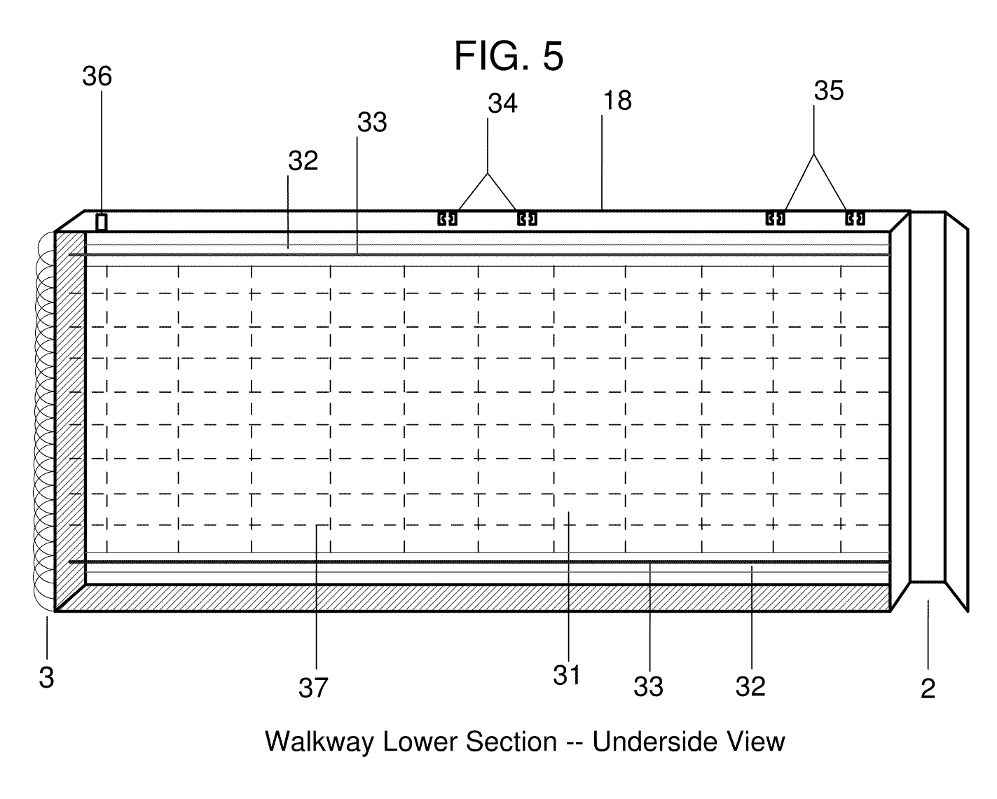

Referring to FIG. 4 of the drawings, the underside view of the walkway upper section is depicted in order to demonstrate the details of the walkway's features. The non-skid top end of the walkway 8 is attached to or molded as part of the upper end of walkway base 1. Walkway center hinge joint 3 is connected both to the upper section of walkway base 1 and to the lower section of the walkway base (shown in FIG. 5). Center handle 23 and forward handle 24 are attached to the side of walkway base 1 by means of an internal hinge (not shown). Hinged locking pin 25 is attached to the side of walkway base 1 with hinged locking pin hinge 26. Hinge 26 serves a dual purpose: it attaches pin 25 to the walkway base 1 and also allows free movement of pin 25 to its locked position when the walkway is extended for use. There is a center handle 23 and forward handle 24 (both visible on drawing), as well as a hinged locking pin 25 on each side of walkway base 1 (one not visible on drawing).

The underside of the walkway floor 20 incorporates integrated structural supports 30 and two apertures 21, one on each side of the walkway floor 20, through which the folding protective side panels protrude above the walkway's surface. The integrated structural supports 30 are incorporated into the molded underside of the walkway floor to provide increased strength and stability for the walkway. The folding protective side panels (not shown) attach to the underside of the walkway floor by means of a metal rod or hinge pin 22, one on each side of the walkway. The forward handle securing mechanism 29 holds the forward handle 24 in place when the handle 24 is in its unlocked position. The center handle securing mechanism 28 holds the center handle 23 in place when the handle 23 is in its unlocked position. Finally, the hinged locking pin securing mechanism 27 holds the hinged locking pin 25 in place when the pin is in its unlocked position.

Referring to FIG. 5 of the drawings, the underside view of the walkway lower section is depicted in order to demonstrate the details of the walkway's features. The non-skid bottom end of the walkway 2 is attached to or molded as part of the lower end of walkway base 18. Walkway center hinge joint 3 is connected both to the lower section of walkway base 18 and to the upper section of the walkway base (shown in FIG. 4). Center handle locking mechanism 34, forward handle locking mechanism 35, and hinged locking pin locking mechanism 36 are attached to the side of walkway base 18, or are configured as part of the molded plastic or aluminum. The handle locking mechanisms hold the handles in place and lock the walkway into a fully-closed position when not extended for use. There is a center handle locking mechanism 34, forward handle locking mechanism 35, and hinged locking pin locking mechanism 36 on each side of walkway base 18, although only one side of the walkway base is fully visible in this illustration. The underside of the walkway floor 31 incorporates integrated structural supports 37 and two apertures 32, one on each side of the walkway floor 31, through which the folding protective side panels protrude above the walkway's surface. The integrated structural supports 37 are incorporated into the molded underside of the walkway floor to provide increased strength and stability for the walkway. The folding protective side panels (not shown) attach to the underside of the walkway floor 31 by means of a metal rod or hinge pin 33, one on each side of the walkway.

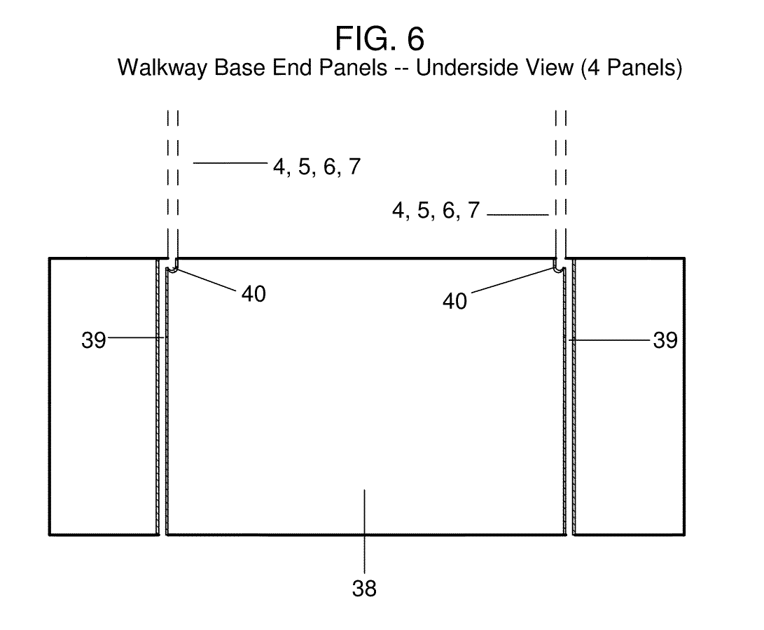

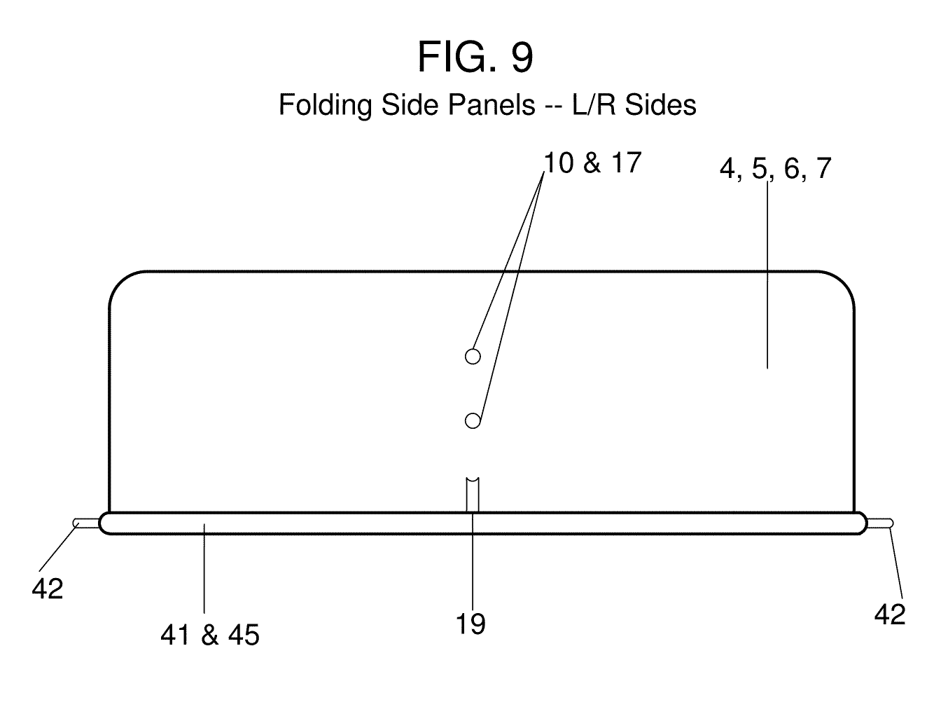

Referring to FIG. 6 of the drawings, the illustration depicts a magnified view of one of the two lateral inside end panels of the underside of each section of the walkway base. Each interior underside lateral end panel of walkway base 38 contains two raised-edge guide channels 39, which are open at the bottom of the lateral end panel and open into the apertures (shown in FIG. 4 and FIG. 5) through which the folding protective side panels protrude above the top surface of the walkway base 38. The raised-edge guide channels 39 allow the folding protective side panels' hinge pins (shown in detail in FIG. 9) to slide upward along the guide channels and come to a rest in the raised-edge guide channel notches 40 at the top of each walkway base lateral end panel. The raised-edge guide channel notches 40 are designed to keep the hinge pin stationary in the correct position at the top of the walkway base lateral end panel while ensuring that the folding protective side panels remain in the proper location in both the folded and secured position when the walkway is not in use and the unfolded and upright position when the walkway is in use. The dashed lines 4,5,6, and 7 show the locations of the folding protective side panels as they would be seen above the walkway surfaces.

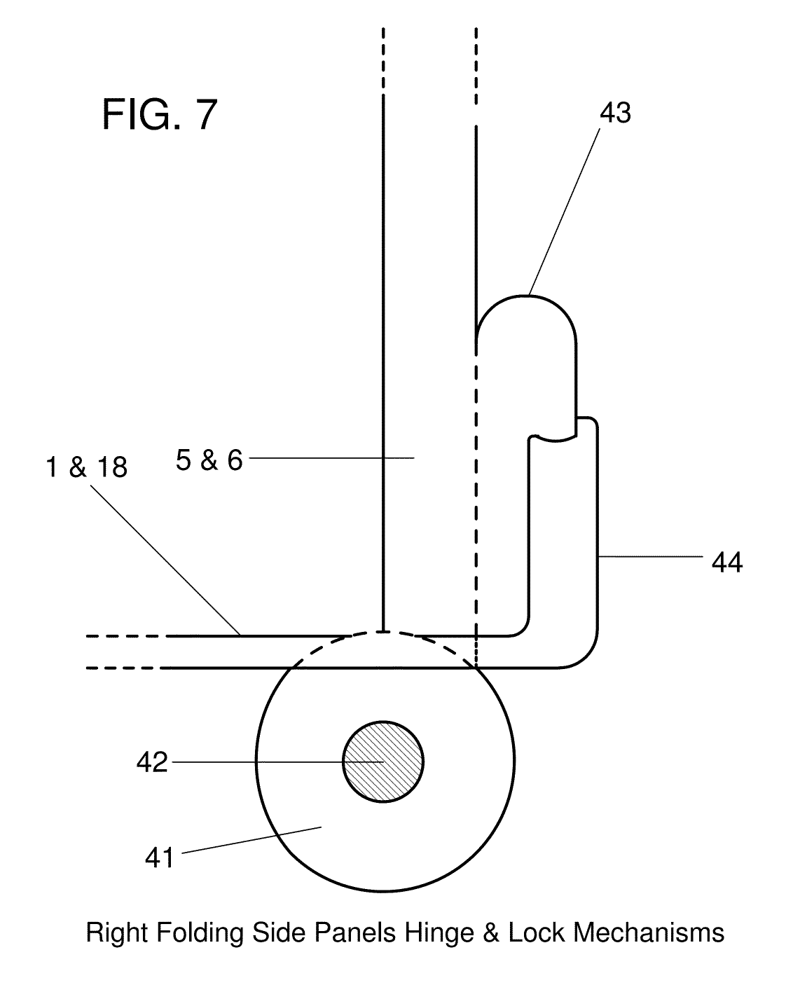

Referring to FIG. 7 of the drawings, the illustration depicts a magnified longitudinal end view of the right folding protective side panel, hinge, hinge pin, and upright locking mechanism. Both right-side folding protective side panels (upper and lower) are identical in design and use. A complete folding protective side panel is formed from either molded plastic or lightweight aluminum, and comprises the above-walkway portion of the panels 5 and 6 plus a hollow hinge 41, which is seated in the raised-edge guide channel notches depicted in FIG. 6. Inserted inside the hollow tube of the hinge 41 is the metal hinge pin 42, which is placed in the raised-edge guide channels as shown in FIG. 6 to slide the folding protective side panels into their correct position, with the hinge 41 seated in the raised-edge guide channel notches (shown in FIG. 6) and the above-walkway portion of the panels 5 and 6 protruding above the walkway surfaces 1 and 18. The right-side folding protective side panels 5 and 6 which protrude above the walkway's surface are offset slightly in relation to the hinge for two reasons: first, to ensure that the panels will fit flush along the walkway's upper surface when folded, secured, and not in use, and second, to permit the weight of the panels to assist in keeping the panels upright when in use.

The folding protective side panel upright locking mechanism 43 as designed is of a raised tubular semi-cylindrical shape and is formed as a part of the external face of the folding protective side panel. The locking mechanism 43 seats into the central vertical semi-cylindrical upright locking mechanism notch 44 of the walkway base raised edge, which protrudes above the walkway base.

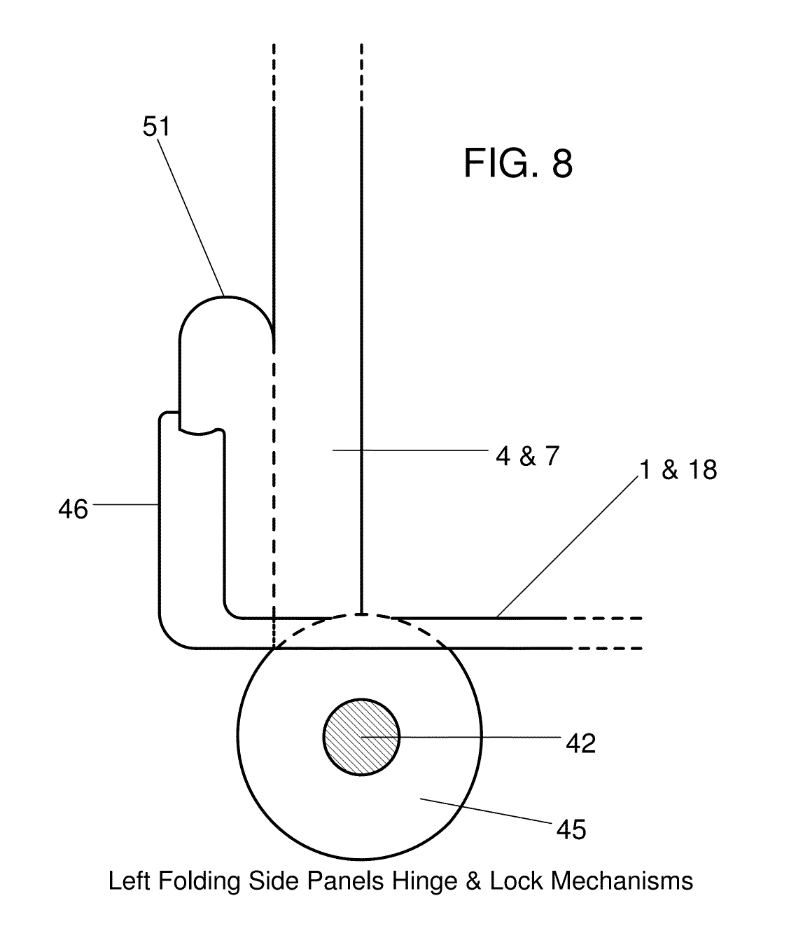

Referring to FIG. 8 of the drawings, the illustration depicts a magnified longitudinal end view of the left folding protective side panel, hinge, hinge pin, and upright locking mechanism. Both left-side folding protective side panels (upper and lower) are identical in design and use. A complete folding protective side panel is formed from either molded plastic or lightweight aluminum, and comprises the above-walkway portion of the panels 4 and 7 plus a hollow hinge 45, which is seated in the raised-edge guide channel notches depicted in FIG. 6. Inserted inside the hollow tube of the hinge 45 is the metal hinge pin 42, which is placed in the raised-edge guide channels as shown in FIG. 6 to slide the folding protective side panels into their correct position, with the hinge 45 seated in the raised-edge guide channel notches (shown in FIG. 6) and the above-walkway portion of the panels 4 and 7 protruding above the walkway surfaces 1 and 18.

The left-side folding protective side panels 4 and 7 which protrude above the walkway's surface are offset slightly in relation to the hinge for two reasons: first, to ensure that the panels will fit flush along the walkway's upper surface when folded, secured, and not in use, and second, to permit the weight of the panels to assist in keeping the panels upright when in use. The folding protective side panel upright locking mechanism 51 as designed is of a raised tubular semi-cylindrical shape and is formed as a part of the external face of the folding protective side panel. The locking mechanism 51 seats into the central vertical semi-cylindrical upright locking mechanism notch 46 of the walkway base raised edge, which protrudes above the walkway base.

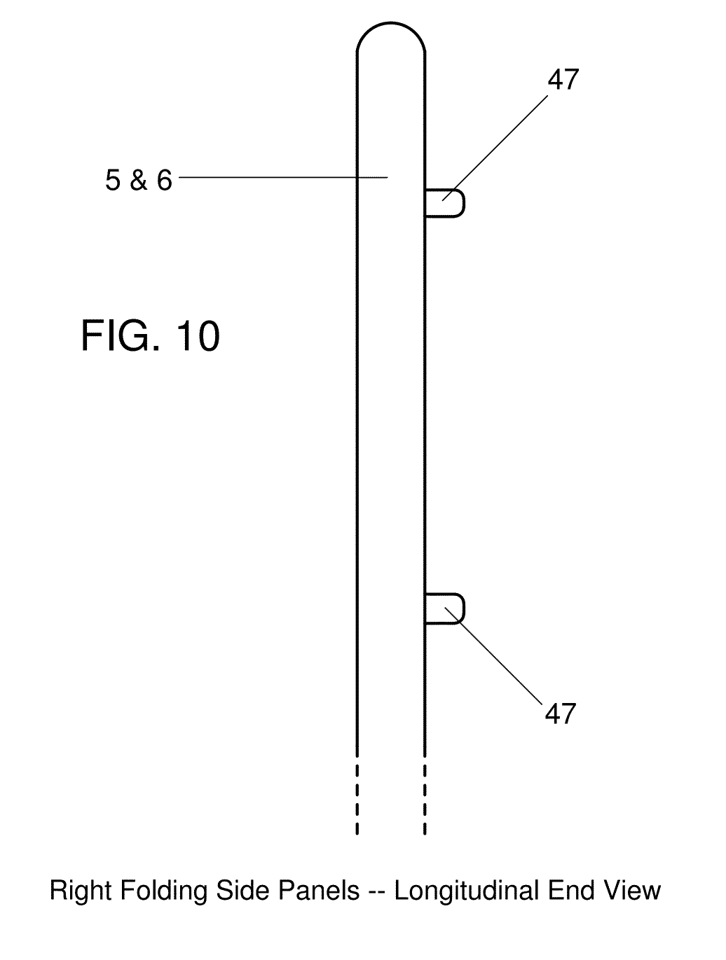

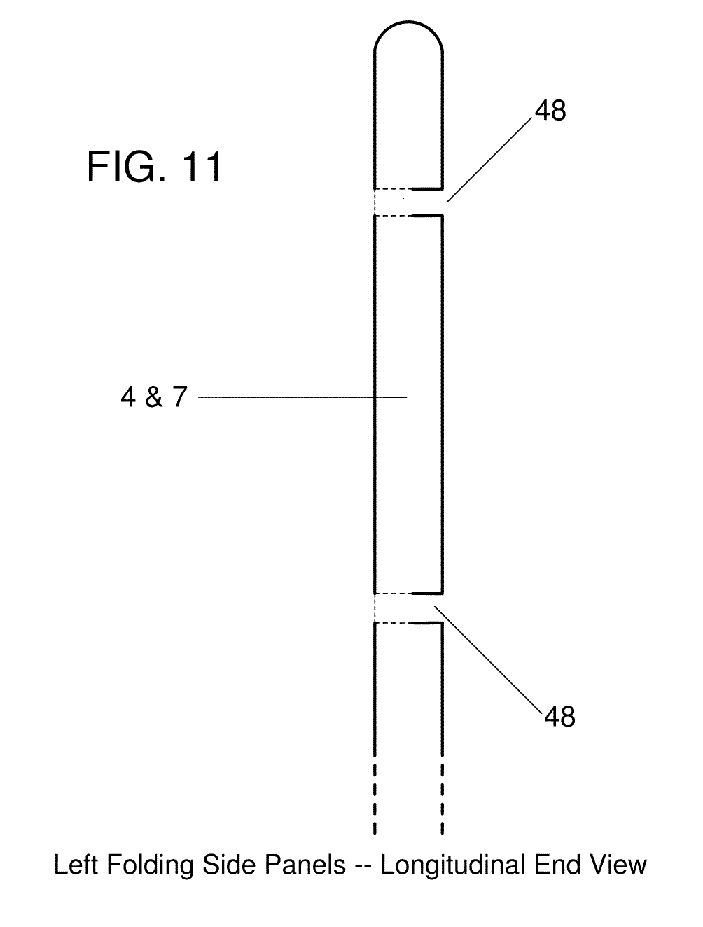

Referring to FIG. 9 of the drawings, the illustration depicts a side view of a folding protective side panel 4, 5, 6, or 7 along with a hinge 41 or 45, hinge pin 42, the center fasteners locations 10 and 17, and the upright locking mechanism location 19. In both right side panels, the center fasteners will be raised circular studs with an elongated dome aspect (shown in FIG. 10), and in both left side panels, the center fasteners will be two circular center fastener holes (shown in FIG. 11) into which the raised center fastener studs of each right-side folding protective side panel will be secured.

Referring to FIG. 10 of the drawings, the illustration depicts a magnified longitudinal end view of a right-side folding protective side panel. Each right-side panel 5 and 6 contains two raised center fastener studs 47 which correspond to the circular center fastener holes of each left-side panel (shown in FIG. 11).

Referring to FIG. 11 of the drawings, the illustration depicts a magnified longitudinal end view of a left-side folding protective side panel. Each left-side panel 4 and 7 contains two circular center fastener holes 48 which correspond to the raised center fastener studs of each right-side panel (shown in FIG. 10).

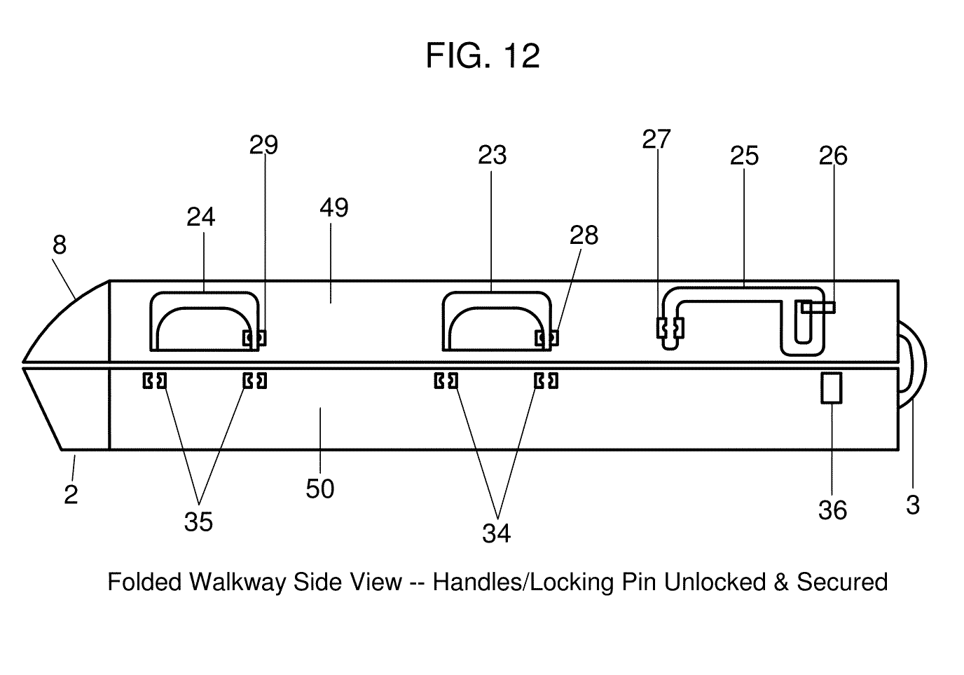

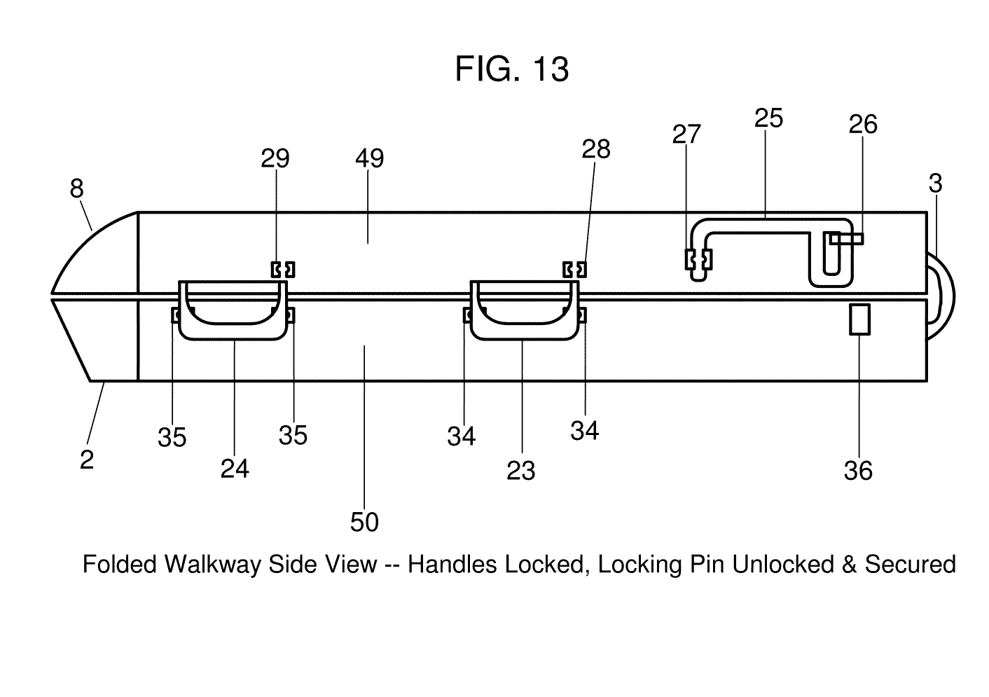

Referring to FIG. 12 of the drawings, the illustration depicts the left side of the entire walkway in a folded but unlocked condition, with the forward and center handles 24 and 23 and the hinged locking pin 25 secured in their unlocked positions. The left and right sides of the walkway are identical. The center handle 23 (shown secured into the center handle securing mechanism 28) serves a dual purpose: when it is unlocked and unsecured, it is used to pick up and carry the folded walkway, and when it is locked (shown in FIG. 13), it helps to lock the walkway into a tightly-folded position when not in use, thus preventing or minimizing potential injuries to users. The forward handle 24 is shown secured into the forward handle securing mechanism 29. The hinged locking pin 25 is shown secured into the hinged locking pin securing mechanism 27.

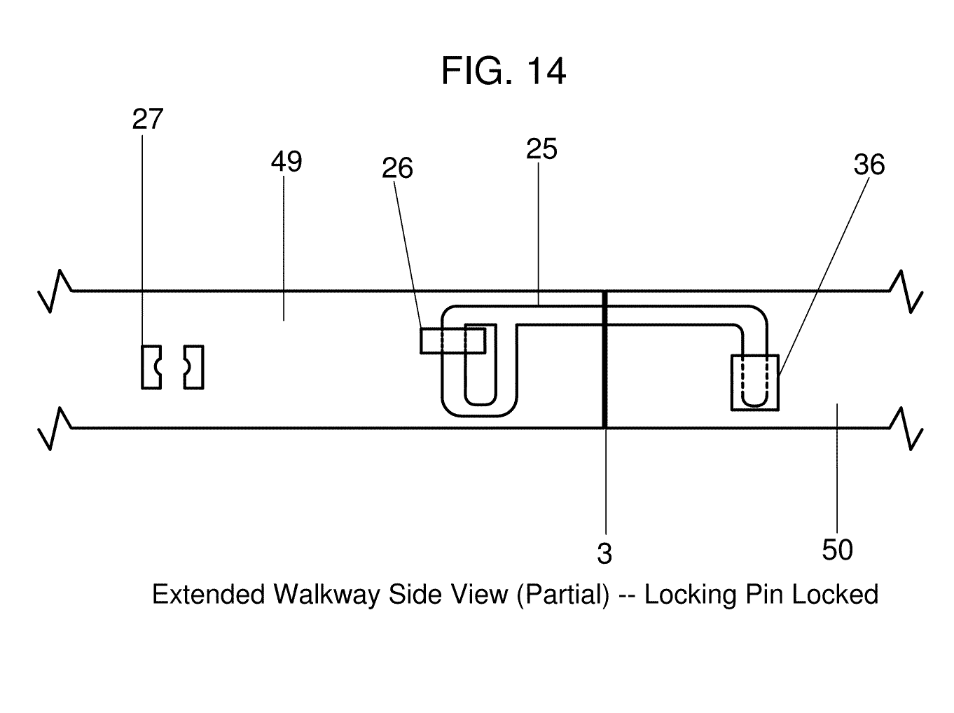

The three securing mechanisms 29, 28, and 27 are used to keep the handles 24 and 23 and the hinged locking pin 25 secured into place as needed. The walkway center hinge joint 3 allows the walkway sections to be folded or extended as necessary. The handles 24 and 23, the hinged locking pin 25, the three securing mechanisms 29, 28, and 27, the hinged locking pin hinge 26, and the non-skid top end 8 of the upper section of the walkway are attached to or molded as part of walkway base side 49 as shown, with non-skid top end 8 attached to the full width of the base. The hinged locking pin hinge 26 serves a dual purpose: it attaches pin 25 to the walkway base side 49 and also allows free movement of pin 25 into its locked position when the walkway is extended for use. The walkway base side 50 (the lower side section of the walkway) contains three locking mechanisms. Forward handle locking mechanism 35 corresponds to forward handle 24, center handle locking mechanism 34 corresponds to center handle 23, and hinged locking pin locking mechanism 36 corresponds to hinged locking pin 25. The handles 24 and 23 are depicted in a locked position in FIG. 13, while the hinged locking pin 25 is depicted in its locked position in FIG. 14. The non-skid bottom end 2 of the lower section of the walkway base is attached to or molded as part of walkway base 50 across the full width of the base.

Referring to FIG. 13 of the drawings, the illustration depicts the left side of the entire walkway in a folded and locked position, with the forward and center handles 24 and 23 locked and the hinged locking pin 25 unlocked but secured. The left and right sides of the walkway are identical. The center handle 23 (shown locked into the center handle locking mechanism 34) serves a dual purpose: when it is unlocked and unsecured, it is used to pick up and carry the folded walkway, and when it is locked as shown, it helps to lock the walkway into a tightly-folded position when not in use, thus preventing or minimizing potential injuries to users. The forward handle 24 is shown locked into the forward handle locking mechanism 35. The forward handle 24, when locked, prevents the gap that would otherwise appear between the two halves of the walkway if the apparatus were to partially unfold, as can occur in current devices.

The hinged locking pin 25 is shown secured into the hinged locking pin securing mechanism 27. The hinged locking pin 25 will only be locked into the hinged locking pin locking mechanism 36 when the walkway is extended for use. The three securing mechanisms 29, 28, and 27 are used to keep the handles 24 and 23 and the hinged locking pin 25 secured into place as needed. The walkway center hinge joint 3 allows the walkway sections to be folded or extended as necessary. The handles 24 and 23, the hinged locking pin 25, the three securing mechanisms 29, 28, and 27, the hinged locking pin hinge 26, and the non-skid top end 8 of the upper section of the walkway are attached to or molded as part of walkway base side 49 as shown, with non-skid top end 8 attached to the full width of the base.

The hinged locking pin hinge 26 serves a dual purpose: it attaches pin 25 to the walkway base side 49 and also allows free movement of pin 25 into its locked position when the walkway is extended for use. The walkway base side 50 (the lower side section of the walkway) contains three locking mechanisms. Forward handle locking mechanism 35 corresponds to forward handle 24, center handle locking mechanism 34 corresponds to center handle 23, and hinged locking pin locking mechanism 36 corresponds to hinged locking pin 25. The handles 24 and 23 and the hinged locking pin 25 are depicted in a unlocked but secured position in FIG. 12, while the hinged locking pin 25 is depicted in its locked position in FIG. 14. The non-skid bottom end 2 of the lower section of the walkway base is attached to or molded as part of walkway base 50 across the full width of the base.

Referring to FIG. 14 of the drawings, the illustration depicts a magnified view of the left side of the walkway as it looks when it is unfolded and locked into its fully-extended position. The left and right sides of the walkway are identical. In this drawing, the hinged locking pin 25 is shown locked into the hinged locking pin locking mechanism 36. This is accomplished by removing the hinged locking pin 25 from the hinged locking pin securing mechanism 27, sliding the pin 25 up through the hinged locking pin hinge 26 to its limit, swinging the pin 25 through 180 degrees, and then lowering the pin 25 into the locking mechanism 36. This locks the walkway safely into its fully-extended position, ready for use by the pet. The position of the walkway center hinge joint 3 is shown for reference, but the center hinge joint 3 is completely hidden by the walkway's upper surface when the walkway is fully extended and locked, as the upper and lower sections of the walkway are flush with each other. The hinged locking pin securing mechanism 27 and the hinged locking pin hinge 26 are attached to or molded as part of walkway base side 49 (the upper side section of the walkway) as shown. The hinged locking pin locking mechanism 36 is attached to or molded as part of walkway base side 50 (the lower side section of the walkway) as shown.

### OATH OR DECLARATION

Form PTO/AIA/01 attached.

### SEQUENCE LISTING

Not Applicable.

What is claimed is:

1. A portable articulated walkway for use by companion animals, incorporating four integral folding protective side panels and comprising:
two separate molded plastic, or in another material, lightweight aluminum, walkway base sections (henceforth designated upper and lower), permanently attached to each other across their central lateral axes by means of a center hinge joint incorporating several interlocking generally tubular flanged collar hinge protrusions with a center hinge pin; and
wherein said center hinge joint allows said separate walkway base sections to rotate around their joined lateral axes relative to each other in such a manner as to form a single rigid mainly planar surface when unfolded and extended and two mainly planar parallel surfaces when folded into a closed configuration; and
wherein each separate walkway base section is primarily rectangular in shape with two rectangular or lozenge-shaped apertures incorporated into the floor of each walkway base section along each longitudinal edge of each section; and
wherein said apertures extend approximately the length of said walkway base floors and are of sufficient width to accommodate the integral folding protective side panels which protrude upward through them; and
wherein each walkway base section incorporates two low longitudinal raised side edges, each containing a central vertical semi-cylindrical notch which forms the female portion of said folding protective side panels' upright locking mechanisms. Said raised side edges serve to increase the strength of the walkway assembly as well as to support the folding protective side panels when they are raised into their vertical and locked positions; and
wherein each walkway base section incorporates two integral lateral end panels and two integral longitudinal side panels extending beneath the edges of the walkway base floors which provide said walkway base floors with stability, strength, and support. Each internal surface of said lateral end panels incorporates two raised-edge guide channels and two raised-edge guide channel notches into which the hinge and hinge pins of said folding protecting side panels are seated, forming the hinge and guide channel notch assemblies. Said assemblies securely attach said folding protective side panels to the walkway bases to accurately guide said folding protective side panels through the rectangular- or lozenge-shaped apertures from the underside of the floors of said walkway bases and to allow said folding protective side panels to extend above and remain secure within the walkway bases in both their folded and upright positions.

2. Four folding protective side panels, primarily rectangular in shape, as recited in claim 1 formed of molded'plastic or, in another material, lightweight aluminum, each attached to said walkway bases by means of a hinge and hinge pin assembly inserted into the integral raised-edge guide channels and raised-edge guide channel notches of said walkway base lateral end panels.

3. Said hinge pins as recited in claim 2 are fully contained within said hinges as recited in claim 2, which are formed as the lower edges of said folding protective side panels as recited in claim 2. Said hinge pins protrude sufficiently from each distal end of said hinges so as to form the male portions of said hinge and guide channel notch assemblies.

4. Folding protective side panels as recited in claim 2 each with a hinge and hinge pin assembly wherein the insertion and locking mechanisms for said assembly into said walkway bases incorporate raised-edge guide channels and raised-edge guide channel notches integrally contained within said walkway base lateral end panels so as to form the female portion of said hinge and guide channel notch assemblies.

5. Two of said folding protective side panels as recited in claim 2 incorporate two circular raised center fastener studs with an elongated dome aspect which form the male portion of the locking mechanism for said folding protective side panels in their closed and secured configuration.

6. Two of said folding protective side panels as recited in claim 2 incorporate two circular center fastener holes which form the female portion of the locking mechanism for said folding protective side panels in their closed and secured configuration.

7. Folding protective side panels as recited in claim 2, each incorporating a raised tubular semi-cylindrical molded protrusion centrally located at the lower exterior edge of each of said panels, which forms the male portion of said folding protective side panels' upright locking mechanisms.

8. Four longitudinal raised side edges, two on each upper and lower walkway base section as recited in claim 1, with each of said raised side edges incorporating a central vertical semi-cylindrical notch which forms the female portion of said folding protective side panels' upright locking mechanisms.

9. A portable articulated walkway as recited in claim 1 incorporating four generally U-shaped tubular hinged securable and lockable handles, two on each side of the upper section of said walkway base, wherein the handles maintain the walkway in a closed configuration when locked and allow said walkway to be unfolded and extended when said handles are secured in their unlocked position.

10. Four hinged securable and lockable handles as recited in claim 9 wherein one centrally-located handle on each side of the upper section of said walkway base can provide the means, when unlocked and unsecured, with which said walkway may be transported or carried when in its folded and closed configuration.

11. Eight locking mechanisms for said handles as recited in claim 9, four on each side of the lower section of said walkway base and two per handle, which are generally raised and notched to accommodate each U-shaped handle and which comprise a means to maintain said handles in their locked positions when said walkway is in its folded and closed configuration.

12. Four securing mechanisms for said handles as recited in claim 9, two on each side of the upper section of said walkway base and one per handle, which are generally raised and notched to accommodate each U-shaped handle and which comprise a means to maintain said handles in their unlocked but secured positions when said walkway is in its unfolded and extended configuration.

13. A portable articulated walkway as recited in claim 1 incorporating two securable and lockable mechanisms for locking said upper and lower walkway base sections into an unfolded and extended configuration for use by a companion animal, and for securing said locking mechanisms when said walkway is in its folded and closed configuration.

14. Two hinged locking pins and two locking mechanisms as recited in claim 13, one on each side of said walkway bases, which cause said walkway to remain fixed in its unfolded and extended position when in use by the companion animal.

15. Each hinged locking pin as recited in claim 14 is primarily a tubular elongated U-shape with one end of said pin having a tubular annularly rectangular shape. One hinged locking pin is attached to each side of said walkway base upper section proximate to the central lateral axis of the walkway.

16. Two hinged locking pins as recited in claim 15, one attached to each side of said walkway base upper section by means of a vertically-oriented raised annular hinge proximate to the central lateral axis of the walkway, through which the annularly rectangular end of each hinged locking pin fits, which allows said pin to move freely through its full range of motion when the pin is moved from its secured position when said walkway is folded and closed into said pin's locked position when said walkway is unfolded and extended, or vice versa.

17. Two hinged locking pin locking mechanisms for said hinged locking pins as recited in claim 14, one on each side of said walkway base lower section proximate to the central lateral axis of the walkway and one per pin, which are generally raised and rectangular with an internal cylindrical cutout of sufficient size and shape to accommodate the free end of each elongated U-shaped pin and which comprise a means to maintain said pins in their locked positions when said walkway is in its unfolded and extended configuration.

18. Two hinged locking pin securing mechanisms for said hinged locking pins as recited in claim 13, one on each side of the upper section of said walkway base and one per pin, which are generally raised and notched to accommodate the free end of each elongated U-shaped pin and which comprise a means to maintain said pins in their unlocked but secured positions when said walkway is in its folded and closed configuration.
